(19) United States
(12) Patent Application Publication
(10) Pub. No.: US 2005/0249947 A1
(43) Pub. Date: Nov. 10, 2005

(54) Equal density pellets or micro pellets

(76) Inventor: Jean-Francois Wittmann, Illzach (FR)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/526,721

(22) PCT Filed: Sep. 2, 2003
(86) PCT No.: PCT/IB03/03885

§ 371 Date: Mar. 4, 2005

(30) Foreign Application Priority Data
Sep. 4, 2002 (GB) 0220551.6

(51) Int. Cl. B32B 19/00

(52) U.S. Cl. 428/357; 264/109

(57) ABSTRACT

The invention relates masterbatches comprising pellets or micro pellets of one or more Single Pigment Concentrates (SPCs) and of one or more Additive Concentrates with at least two different chemical compositions, or of two or more Single Pigment Concentrates (SPCs) with at least two different chemical compositions, or of two or more Additive Concentrates with at least two different chemical compositions, characterised in that the pellets or micro pellets with different chemical compositions are of substantially equal density, size, shape and/or electrostatic properties. The invention further relates to a process for preparing said pellets or micro pellets in that a Single Pigment Concentrate (SPC) or Additive Concentrate with a chemical composition of specific weight is taken as reference and that the specific weight of all other SPCs or Additive Concentrates is adjusted to the specific weight of the reference by adapting the concentration of pigment (in the SPC) or additive (in the Additive concentrate) or by adding a filler or a blowing agent to the SPCs or Additive Concentrates.

### BACKGROUND OF THE INVENTION

For coloring polymers, the plastic manufacturers prefer to purchase ready to use products from color manufacturers instead of working with the basic colorants (pigments and dyes) which require a comprehensive formulation and color matching expertise in order to achieve the requested color and the specific properties of the polymers.

The most common product forms sold by the color manufacturers are pre-colored resins or color concentrates. Color concentrates contain a high concentration of pigments or dyes in a carrier system. Such color concentrates are mixed by the plastic manufacturer with uncolored polymer and are then manufactured into semifinished products or final products. The color concentrates are commonly used in pelletized form (also known as masterbatches) or liquid form (also known as liquid color).

The manufacturers of pre-colored resins use virgin resin and add colorants and functional additives. The final product is a pellet which is ready for processing. Compared to other methods of coloring resin, the use of pre-colored resin is a rather expensive manufacturing practice. Pre-colored resin is much more expensive than uncolored resin plus a color concentrate.

The manufacturers of color concentrates frequently have to produce small quantities of masterbatches (usually 10 to 50 kg) within short lead times due to the fact, that the plastic manufacturers want to keep only minimal stock of color concentrates in case a color becomes suddenly obsolete.

The color concentrates, either in liquid form or in the pellet form (masterbatch) have to be mixed with the uncolored resin in a particular let-down ratio in order to achieve the desired color. The mixing can be done either by manual mixing, or, more commonly, by a batch-blend process using automated dosing equipment.

Liquid colors are normally pumped directly into the feed throat of the processing machine (e.g. an injection molding machine, a blow molding machine, a melt spinning system or the like) by using a small peristaltic pump. A problem related with liquid color concentrates is, that the liquid carrier can have a negative impact on the physical properties of the polymer. Further disadvantage of liquid colors compared to masterbatches are a more difficult handling, the cleaning of the machine between color changes, and the processing of the liquid color. However, the coloring costs with liquid colors are lower compared to conventional masterbatches.

For most plastic manufacturers, the use of masterbatches is the preferred method for coloring of plastics. Ease of handling and low costs compared to pre-colored resins are the main advantages for these products. Unlike liquid colors, the compatibility of masterbatches with the resin is excellent, since the carrier material of the masterbatch is in most cases identical with the resin.

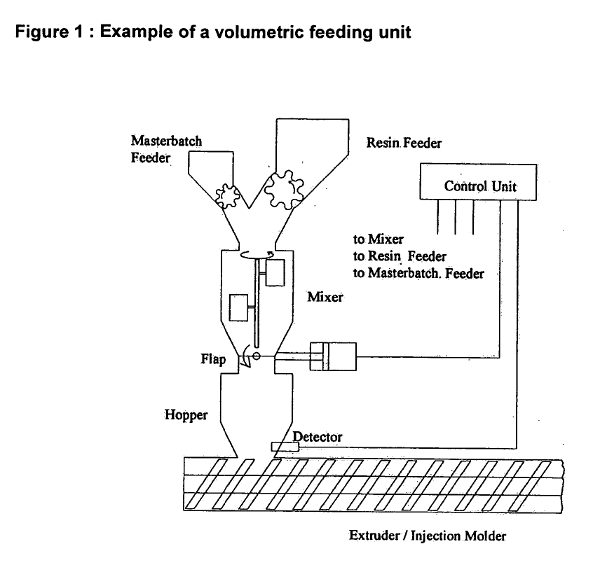

An example of such automated dosing equipment for masterbatches is the volumetric feeding unit as represented by FIG. 1. The feeding unit comprises a resin feeder next to a masterbatch feeder, a mixer in a mixing area, a flap between the mixing unit and the hopper and a hopper mounted on an extruder or injection molder. The resin feeder, the masterbatch feeder, the mixer and the flap are controlled by a control unit, comprising a detector at the passage way from the hopper to the extruder or injection molder.

Masterbatches are commonly supplied in pellet or in micro-pellet form. There are few ways to produce a masterbatch. The first and most common way used by the masterbatch manufacturers is a so called one step process. During this process, pigments (or dyes), functional additives and the polymer carrier are mixed, the mixture is then processed through a dispersion unit, e.g. a co-rotating twin screw extruder.

The color concentrates (masterbatches) can also be obtained in a so called two step process, wherein in a first step, the masterbatch manufacturers produce a Single Pigment Concentrate (SPC). SPC is a masterbatch preparation containing only one pigment or dye (generally in very high concentration) fully dispersed in a resin carrier optionally comprising further additives. This first process step is very similar to the one step process.

In a second step, different SPCs are mixed together in order to achieve the required color specifications of the customer and to get the tailor made masterbatch. To reduce the pigment concentration, the SPCs are mixed together with some carrier resin. Since SPCs are already fully dispersed, only a mixing process is necessary. This can be performed for example with a single screw or twin screw extruder.

Compared to the one step process, the two step process leads to a much higher flexibility in the production of tailor made masterbatches and is also more cost-effective for the production of small production batches (low cleaning costs of the machines, higher output rate compared to the one step process). This is increasingly important since the color lifetime in the plastics business is becoming shorter and the average lot size is becoming smaller.

The main disadvantage of this process is that it requires a second extrusion which raises the production cost of the resulting tailor-made masterbatches and which can affect the mechanical properties of the carrier polymer and therefore also the mechanical properties of the final product.

A possibility to avoid the second extrusion is to separately add each SPC to the resin during processing. This requires a dosing equipment for each SPC. The dosing units are mounted directly onto the feed throat of the processing equipment (e.g. an injection molding machine, a blow molding machine, a melt spinning system or the like). This system, a so-called multi dosing system, is not commonly used because it is very sophisticated and expensive.

The direct feeding of pre-mixed SPCs in a single dosing system in order to avoid the second extrusion, leads to a separation or de-mixing of the different components due to the difference in bulk density, the difference in electrostatic properties of the different components and due to the difference in form and size of the pellets.

The separation or de-mixing can take place during the following processing steps:
loading of the pre-mixed SPCs in transport or storage containers
transport of the pre-mixed SPCs in transport containers
pneumatic conveying from the storage containers into the dosing unit
feeding of the injection molding or extrusion machine under the influence of the equipment's' vibration.

The separation leads to inconsistent and inhomogeneous color of the final products.

The separation in a single dosing system can be avoided by using an automated dosing equipment, i.e. a volumetric or gravimetric feeder. The dosing unit is mounted directly onto the feed throat of the processing equipment (e.g. an injection molding machine, a blow molding machine, a melt spinning system or the like). The resin is filled either manually into a hopper attached to the dosing unit or pneumatically conveyed from silos or storage containers directly into the dosing unit (see FIG. 1).

Another approach to avoid separation of components is disclosed in JP62009915, wherein a plastic molding method is described which provides for plastic pellets with different load or properties which do not separate in the feed. JP62009915 proposes to use larger pellets if the specific gravity (density) and/or antistatic properties of the material are low; or to use smaller pellets if the specific gravity (density) and/or the antistatic properties are high. The process of JP62009915 therefore compensates the different densities of the material, as a first parameter, by adapting the size of the pellets and, additionally, takes into account the dielectricity of the material as a second parameter.

### SUMMARY OF THE INVENTION

The present invention provides a method for preventing the separation of at least two different Single Pigment Concentrates (SPC) and/or Additive Concentrates in pellet or micro pellet form.

Pellets or micro pellets according to the invention are characterised in that one or more Single Pigment Concentrates (SPCs) and of one or more Additive Concentrates with at least two different chemical compositions,
or of two or more Single Pigment Concentrates (SPCs) with at least two different chemical compositions,
or of two or more Additive Concentrates with at least two different chemical compositions,
with substantially equal density are provided.

The invention thereby enables the preparation of more cost effective tailor-made masterbatches with SPC and/or Additive Concentrates by avoiding the multi-extrusion. The invention further provides a process with higher flexibility and reactivity in the production of tailor made masterbatches.

In a further aspect, the invention provides:
a method of coloring plastic by using a blend (or mixture) of SPCs of at least two components.
a method of bringing properties to the plastic by using a blend (or mixture) of Additive Concentrates of at least two components.
a method of coloring and bringing properties to the plastic by using a blend of SPCs and Additive Concentrates of at least two components.

The Additive Concentrates are defined as preparations containing at least one active ingredient dispersed in a resin carrier, wherein the active ingredient is selected from the group consisting of anti-blocking, anti-fogging, anti-microbial, antioxidant, anti-slipping, anti-static or cleaning agents, compatibilizers, conductive agents, corrosion inhibitors, de-nesting agents, drying agents, fillers, flame retardants, foaming agents, infrared agents, laser marker agents, lubricants, matting agents, nucleating agents, opacifiers, optical brightener, phosphorescent agents, photo-degradable agents, processing aids and/or UV stabilisers.

The Single Pigment Concentrates (SPCs) are defined as preparations containing only one pigment or dye dispersed in a carrier resin optionally comprising additives (see the list above). A SPC contains 20 to 80% by weight of a pigment or a dye and 80 to 20% by weight of a carrier polymer. Pigments are inorganic or organic pigments.

The carrier polymer is a thermoplastic polymer or a blend of thermoplastic polymers selected from polyolefins, polyesters, polyamides, polyacrylates, polycarbonates, polyurethanes, polystyrenes and copolymers thereof. It is required, that the carrier polymer for the masterbatch is compatible with the virgin polymer used for the final product.

The SPCs and Additive Concentrates are provided in pellet or in micro pellet form. The micro pellet form is preferred for an improved color uniformity of the final product due to the smaller size and better statistical distribution of the micro pellets. The size of the pellets is from larger than 2.0 mm to 4.0 mm; the size of the micro pellets is from about 0.5 mm to 2.0 mm.

This technology can be easily introduced in a variety of applications for example in injection molding, blow molding, extrusion or spin dyeing. The color consistency is insured from the beginning to the final product since the mixture of the components stays homogeneous over the time.

Preferred industrial applications for the masterbatches according to the invention are blown film, blow molding, calendering, cast film, injection molding, pipe extrusion, profile extrusion, sheet extrusion, spin dyeing and stretch blow molding.

The main characteristics of the components (micro pellets or pellets) according to the invention are:
controlled density (specific weight) of the components (micro pellets or pellets)
controlled size and shape of the components (micro pellets or pellets)
controlled electrostatic properties of the components (micro pellets or pellets)

Masterbatches according to the invention consist of micro pellets or pellets of different chemical composition but with substantially equal density.

The density of the pellets or micro pellets is from 0.5 to 1.5 g/cm³ and preferably from 0.6 to 1.1 g/cm³.

Preferred masterbatches according to the invention consist of micro pellets or pellets of different chemical composition but with substantially equal density and substantially equal size and shape.

Most preferred masterbatches according to the invention consist of micro pellets or pellets of different chemical composition but with substantially equal density, substantially equal size and shape and substantially equal electrostatic properties.

Micro pellets or pellets of different chemical composition but with substantially equal density according to the invention are obtained by adjusting the pigment content, by adjusting the filler content and/or by adding a blowing agent to produce a hollow pellet.

Micro pellets or pellets of different chemical composition but with substantially equal density and substantially equal size and shape are obtained by adjusting the pigment content, adjusting the filler content and/or adding a blowing agent to produce a hollow pellet and subjecting the blend to the same production and shaping process.

To prevent the separation of the mixture due to the electrostatic charge of the components, an antistatic additive (for example stereates or lauryl amides) is added in the blend to obtain the most preferred micro-pellets or pellets of different chemical composition but with substantially equal density, substantially equal size and shape and substantially equal electrostatic properties.

The invention therefore enables the production of SPCs and Additive Concentrates of different chemical composition with the same specific weight (density) of the pellets or micro-pellets.

The adjustment of the parameters of the different SPCs and Additive Concentrates can be achieved as follows:

1) Take the SPC or Additive Concentrate with the composition of lower specific weight as reference and reduce the specific weight of all other SPCs and Additive Concentrates to the specific weight of the reference by:
reducing the concentration of pigment (respectively additive) of the SPCs or Additive Concentrates
or by adding a blowing agent in order to form “hollow” pellets or micro pellets.

2) Take the SPC or Additive Concentrate with the composition of higher specific weight as reference and increase the specific weight of all other SPCs and Additive Concentrates to the specific weight of the reference by
adding a filler.

The filler can include every material or composition having a higher density than the reference like for example oxides, carbonates, sulfates and silicates.

3) Take one of the SPCs or Additive Concentrates as a reference and increase the specific weight of the SPCs or Additive Concentrates with lower specific weight to the specific weight of the reference and reduce the specific weight of the SPCs or Additive Concentrates with higher specific weight to the specific weight of the reference as described above.

In the following, two possible procedures for obtaining equal density pellets or micropellets are described in detail. Although the procedure is described for SPC's, it is mutually applicable to Additive Concentrates as well as to mixtures of SPC's and Additive Concentrates.

A) A standard SPC with a particular concentration in a selected polymer is identified as a reference. Then the SPC's to be adjusted at equal density are extruded in the same shape and size in the same selected polymer.

The relative density compared to the reference is determined. For those SPC's with a higher density, the pigment and/or filler load is decreased. For those SPC's with a lower density, the pigment and/or filler load is increased.

In an itterative process, the SPC's are again extruded in the same shape and size in the same selected polymer and the relative density is again compared to the reference. The itterative process is terminated when the density of the adjusted SPC's is within a defined density range close to the reference.

B) A standard SPC at a particular concentration in a selected polymer is identified as a reference. Then the SPC's to be adjusted at equal density are extruded in the same shape and size in the same selected polymer.

The relative density compared to the reference is determined. For those SPC's with a higher density, the amount of blowing agent is increased. For those SPC's with a lower density, the amount of blowing agent is decreased.

In an itterative process, the SPC's are again extruded in the same shape and size in the same selected polymer and the relative density is again compared to the reference. The itterative process is terminated when the density of the adjusted SPC's is within a defined density range close to the reference.

Preferred fillers are calcium salts, barium salts or silicates. In particular preferred are carbonates, sulphates and silicate hydrates, as well as so called clays and nano-clays. Most preferred fillers are calcium carbonate and barium sulphate.

In principal, fillers as used in the present invention are defined to be compounds with a density above 1 g/cm³ according to ISO 787-10.

Preferred blowing agents are chemical blowing agents, in particular endothermic or exothermic blowing agents, for example such as are available in the Hydrocerol® range of Clariant.

Antistatic agents are added, when necessary, to the SPCs and Additive Concentrates to prevent the de-mixing of the mixture, respectively the blend, due to electrostatic charge of the SPCs or Additive Concentrates.

All the tests performed in the examples show that the mixture of different SPCs and or Additive Concentrates with equal density according to the invention, stay homogeneously mixed, e.g. when vibrated with a back and forth shaker, compared to a mixture of SPCs with non-equal density.

### EXAMPLES

Equal Density Adjustment of SPCs:

As a standard organic SPC, a C.I. Pigment Red 214 (commercially available form Clariant as PV Fast Red BNP) at a concentration of 40% in polypropylene has been identified as a reference with a bulk density of 0.62 g/cm³ (see F below).

Then the SPCs to be adjusted at equal density have been extruded in polypropylene and pelletized in cylindrical shape at a size of 3 mm length and 2 mm diameter.

250 g of each of the SPC pellets have been put in a measuring glass containing 500 ml of water. The pellets were kept under water by putting a screen above. The difference in density compared to the reference has been determined by comparing the difference in waterlevel in the measuring glass.

For those SPC's where the waterlevel is lower than the reference (=higher density), the pigment and/or filler load has been decreased. E.g. for a SPC of C.I. Pigment White 6 containing 70% of TiO₂, the TiO₂ load has been reduced to 28% in several itterative steps (see A below).

The itterative process was terminated when the density of the adjusted SPC's were within a density range of +/−0.02 g/cm³ to the reference.

For those SPC's where the waterlevel is higher than the reference (=lower density), the pigment and/or filler load has been increased. E.g. for a pure polypropylene, 30% of CaCO₃ were added as a filler in several itterative steps.

The itterative process was terminated when the density of the adjusted PP was within a density range of +/−0.02 g/cm³ to the reference.

The following SPCs have been prepared as described:
A) White C.I. Pigment White 6: 28% of TiO₂ has been mixed with 72% of polypropylene and the mixture has been dispersed with a twin screw extruder.
B) White 2 C.I. Pigment White 6: 70% of TiO₂ has been mixed with 30% of polypropylene and the mixture has been dispersed with a twin screw extruder.
C) Yellow C.I. Pigment Yellow 34: 27% of Chrome Yellow has been mixed with 63% of polypropylene and the mixture has been dispersed with a twin screw extruder
D) Yellow C.I. Pigment Yellow 119: 25% of Zinc/Ferric oxide has been mixed with 75% of polypropylene and the mixture has been dispersed with a twin screw extruder
E) Black C.I. Pigment Black 7: 35% of Carbon black has been mixed with 65% of polypropylene and the mixture has been dispersed with a twin screw extruder.
   The bulk density of these SPCs has then been adjusted to 0.62+/−0.02 g/cm³ according to ISO 697 by adjusting the concentration of the pigment dispersed in the polymer carrier.
      And
F) Red C.I. Pigment Red 214: 40% of PV Fast Red BNP (commercially available form Clariant) has been mixed with 60% of polypropylene and the mixture has been dispersed with a twin screw extruder
   The bulk density of this SPCs has not been adjusted, as it was used as a reference for adjusting A and C-E above as well as G below.

The following Additive Concentrate has been prepared as described:
G) Anti-oxidant Irganox® B501W (Trademark of Ciba Specialities Inc.): 15% of Irganox B501W has been mixed with 30% of calcium carbonate and 55% of polypropylene and the mixture has been dispersed with a twin screw extruder.

The bulk density of this Additive Concentrate Blend has been adjusted to 0.62+/−0.02 g/cm³ according to ISO 697 by adding a filler (calcium carbonate).

| | Component (SPC or | Bulk Density |
|---|---|---|
| | Additive Concentrate) | (g/cm³) |
| A | White P.W. 6 | 0.60-0.62 |
| B | White 2 P.W. 6 | 1.04-1.06 |
| C | Yellow PY 34 | 0.60-0.62 |
| D | Yellow PY 119 | 0.61-0.63 |
| E | Black P.Bk. 7 | 0.60-0.62 |
| F | Red P.R. 214 | 0.62-0.64 |
| G | Irganox ® B501W | 0.62-0.64 |

### Examples 1-4

The following batches have been prepared:

Batch 1

| | |
|---|---|
| 9.98% | Irganox ® B501W |
| 78.63% | White P.W. 6 |
| 4.27% | Yellow P.Y. 34 |
| 6.30% | Yellow P.Y. 119 |
| 0.82% | Black P.Bk. 7 |

Total batch size: 50 g + 0.025 g Nopcostat ® HS (Antistatic)
(Trademark of Cognis)

Batch 2

| | |
|---|---|
| 6.63% | Irganox ® B501W |
| 31.84% | White P.W. 6 |
| 56.52% | Yellow P.Y. 34 |
| 2.95% | Red P.R. 242 |
| 2.06% | Black P.Bk. 7 |

Total batch size: 50 g + 0.025 g Nopcostat ® HS (Antistatic)
(Trademark of Cognis)

Batch 3

| | |
|---|---|
| 9.98% | Irganox ® B501W |
| 78.63% | White P.W. 6 |
| 4.27% | Yellow P.Y. 34 |
| 6.30% | Yellow P.Y. 119 |
| 0.82% | Black P.Bk. 7 |

Total batch size: 50 g

Batch 4

| | |
|---|---|
| 6.63% | Irganox ® B501W |
| 31.84% | White P.W. 6 |
| 56.52% | Yellow P.Y. 34 |
| 2.95% | Red P.R. 242 |
| 2.06% | Black P.Bk. 7 |

Total batch size: 50 g

The following tests have been carried out:

The batches 1 to 4 have been agitated with a back and forth shaker from Infors AG at the speed of 400 rpm for 24 hours.

Batches 1 and 2 (with antistatic agent) stay substantially homogeneous whereas the batches 3 and 4 (without antistatic agent) show a significantly higher de-mixing tendency due to electrostatic charging.

### Comparative Examples 5-8

The following 3 batches have been prepared by filling two separate layers in a bottle:

Batch 5

| | |
|---|---|
| Upper layer: 50.0% | White 2 P.W. 6 |
| Bottom layer: 50.0% | Black P.Bk. 7 |

Total batch size: 50 g

Batch 6

| | |
|---|---|
| Upper layer: 50.0% | Black P.Bk. 7 |
| Bottom layer: 50.0% | White 2 P.W. 6 |

Total batch size: 50 g

Batch 7

| | |
|---|---|
| Upper layer: 50.0% | White P.W. 6 |
| Bottom layer: 50.0% | Black P.Bk. 7 |

Total batch size: 50 g

The following batch has been prepared by filling a random mixture in a bottle:

Batch 8

| | |
|---|---|
| 50.0% | White P.W. 6 |
| 50.0% | Black P.Bk. 7 |

Total batch size: 50 g

The following tests have been carried out:

The Batches 5 to 8 have been agitated with a back and forth shaker from Infors AG at the speed of 400 rpm for 24 hours.

The two layers of Batch 5 were completely mixed due to the difference of bulk densities, whereas in Batch 6 only a few black granules arrived in the white layer. (In Batch 6 the higher density of the white component prevents the pellets from moving upward whereas the lower density of the black component prevents the pellets from moving downward.)

The two layers of Batch 7 stayed substantially separate due to the equal bulk density. (Only a few black and white granules arrived in the opposite layer.)

In the random mixture of Batch 8 no de-mixing could be observed due to the equal bulk density.

1. Pellets or micro pellets of one or more single pigment concentrates and of one or more additive concentrates, wherein the one or more single pigment concentrates and the one or more additive concentrates have at least two different chemical compositions,
or two or more single pigment concentrates with at least two different chemical compositions,
or two or more additive concentrates with at least two different chemical compositions,
wherein the pellets or micro pellets are of substantially equal density.

2. Pellets or micro pellets according to claim 1, wherein the pellets or micro pellets are of substantially equal size.

3. Pellets or micro pellets according to claim 1, wherein the pellets or micro pellets are of substantially equal shape.

4. Pellets or micro pellets according to claim 1, wherein the pellets or micro pellets have substantially equal electrostatic properties.

5. Pellets or micro pellets according to claim 1, wherein the particle size of the pellets is from larger than 2.0 mm to 4.0 mm.

6. Pellets or micro pellets according to claim 1, wherein the density of the pellets or micro pellets is from 0.5 to 1.5 g/cm³.

7. A masterbatch comprising pellets or micro pellets according to claim 1.

8. A process for the preparation of pellets or micro pellets according to claim 1, comprising the step of forming a reference from the single pigment concentrate or additive concentrate with the chemical composition of lower specific weight and reducing the specific weight of the one or more single pigment concentrates and/or one or more additive concentrates to the specific weight of the reference by reducing the pigment concentration of the one or more single pigment concentrates and/or reducing the additive concentration of the one or more additive concentrates.

9. A for the preparation of pellets or micro pellets according to claim 1, comprising the steps of forming a reference from the single pigment concentrate or additive concentrate with the chemical composition of lower specific weight and that and reducing the specific weight of the one or more single pigment concentrates and/or the one or more additive concentrates to the specific weight of the reference by adding a blowing agent to the one or more single pigment concentrates and/or additive concentrates.

10. A Process for the preparation of pellets or micro pellets according to claim 1, comprising the step of forming a reference from the single pigment concentrate or additive concentrate with the chemical composition of higher specific weight and increasing the specific weight of the one or more single pigment concentrates and/or one or more additive concentrates to the specific weight of the reference by adding a filler to the one or more single pigment concentrates and/or one or more additive concentrates.

11. A process for making a masterbatch comprising the step of adding pellets or micro pellets according to claim 1 to reaction mixture during the manufacture of the masterbatch.

12. A process for coloring and/or imparting additive properties on a plastic comprising the step of adding pellets or micro pellets according to claim 1 to the reaction mixture during the formation of the plastic.

13. The process according to claim 12, wherein the plastic is in the form of a fiber.

14. A plastic article made with at least one masterbatch according to claim 7.

15. Use according to claim 14 of the masterbatches according to claim 7 for bringing color and additive properties into fibres.

16. Pellets or micro pellets according to claim 1, wherein the particle size of the micro pellets is from 0.5 to 2.0 mm.

17. Pellets or micro pellets according to claim 1, wherein the particle size of the pellets is from larger than 2.0 mm.

18. Pellets or micro pellets according to claim 1, wherein the particle size of the pellets is from larger than 4.0 mm.

19. Pellets or micro pellets according to claim 1, wherein the density of the pellets or micro pellets is from 0.6 to 1.1 g/cm³.

20. A plastic made in accordance with the process of claim 12.
